(19) United States
(12) Patent Application Publication
(10) Pub. No.: US 2008/0043132 A1
(43) Pub. Date: Feb. 21, 2008

(54) Method and apparatus for displaying a power-up image on an imaging device upon power-up

(75) Inventor: Shawn Gunter, Boise, ID (US)

Correspondence Address: DICKSTEIN SHAPIRO LLP, 1825 EYE STREET, NW, WASHINGTON, DC, 20006, US

(73) Assignee: MICRON TECHNOLOGY, INC.

(21) Appl. No.: 11/506,944

(22) Filed: Aug. 21, 2006

(51) Int. Cl. H04N 5/222; H04N 5/225; G03B 13/02

(52) U.S. Cl. 348/333.01; 348/372; 396/374

(57) ABSTRACT

An imaging device and/or system which has an image sensor module for generating first image data representing images captured by the image sensor module. The imaging device also has an image processor for receiving and processing the first image data. The image processor has a power-up image circuit for generating and/or outputting second image data representing a power-up image. When the imaging device is being powered up, the image processor is capable of selectively outputting the first and second image data for display.

### FIELD OF THE INVENTION

Semiconductor devices, and in particular imaging devices, systems, and methods of storing and displaying a power-up image are provided.

### BACKGROUND OF THE INVENTION

Solid state image sensors, also known as imaging device, have commonly been used in various photo-imaging applications. These imaging devices, when used with appropriate imaging circuits, capture, process, store, and display images for various purposes. For example, an imaging device absorbs incident radiation of a particular wavelength (e.g., optical photons or x-rays) and generates an electrical signal corresponding to the absorbed radiation. An imaging device is typically formed with an array of pixels containing photosensors, such as photogates, phototransistors, photoconductors, or photodiodes. Each photosensor produces a signal corresponding to the intensity of light impinging on that element when an image is focused on the pixel array. The signal is then processed and used for storage, printing, display or other purposes.

There are a number of different types of semiconductor-based imaging devices, including charge coupled devices (CCDs), photodiode arrays, charge injection devices (CIDs), hybrid focal plane arrays, and complementary metal oxide semiconductor (CMOS) imaging devices. Current applications of solid state imaging devices include cameras, mobile phones, scanners, machine vision systems, vehicle navigation systems, video telephones, computer input devices, surveillance systems, auto focus systems, star trackers, motion detector systems, and image stabilization systems among other uses.

When an imaging device is being powered up, various registers in the imaging device undergo initialization before the imaging device can operate to capture images during normal use. No image is output during initialization. Consequently, the user will see a blank display until initialization is completed. Such blank display can be a nuisance to the user as it occurs each time the imaging device is being powered up.

Accordingly, it is desirable to provide an imaging device and/or system that overcomes or at least reduces the effects of the above discussed deficiencies.

### BRIEF DESCRIPTION OF THE DRAWINGS

FIG. 1 is a block diagram of an imaging device having an image processor formed according to various embodiments;

FIGS. 2 to 5 are block diagrams of additional imaging devices formed according to various embodiments; and

FIG. 6 illustrates an imaging system comprising an imaging device formed according to various embodiments.

### DETAILED DESCRIPTION OF THE INVENTION

In the following detailed description, reference is made to the accompanying drawings, which form a part hereof and show by way of illustration specific embodiments and examples in which the invention may be practiced. These embodiments and examples are described in sufficient detail to enable one skilled in the art to practice the invention. It is to be understood that other embodiments and examples may be utilized, and that structural, logical, and electrical changes and variations may be made.

Embodiments provide an imaging device and/or system capable of displaying a power-up image during initialization of the imaging device while it is being powered up and provide a method of displaying a power-up image during initialization of an imaging device. The imaging device and/or system can be formed to capture images during normal use of the imaging device and/or system and comprise an image sensor module for generating first image data representing one or more images captured by the image sensor module. For example, the first image data can correspond to the light (e.g., red, blue, and green light) impinging on the image sensor module. The first image data can be processed (e.g., digitizing and/or color demosaicing) by an image processor before being output from the imaging device for storage, display, printing, editing, or other types of image data processing.

The image processor can also be formed to provide second image data representing a power-up image. Such power-up image can be provided and/or stored in the image processor beforehand so as to be displayed when the imaging device is being powered up. For example, the image processor can comprise a power-up image circuit for generating and/or outputting such second image data in any of various ways. The second image data can be stored in the power-up image circuit, such as in a memory device (e.g., a non-volatile memory). Alternatively, the second image data can be generated and/or output by the power-up image circuit, such as through an algorithm implementing circuit (e.g., a programmable logic device programmed with an algorithm, which when executed generates a pattern for the power-up image). The second image data can be provided either during manufacturing or during normal use of the imaging device. The power-up image can be in any of various forms, such as e.g., product information, a company logo, or a user created image.

According to one embodiment, the image processor is capable of selectively outputting one of the first and second image data. For example, the second image data can be output to display the power-up image when the imaging device is undergoing initialization. The power-up image can be displayed for a predetermined time period and/or during the initialization period of one or more registers in the image processor. The image processor can also output the first image data to a display device to display one or more captured images after the imaging device is powered up. For example, the image processor can employ a selection circuit for receiving both first and second image data and selectively outputting one of the first and second image data.

According to another embodiment, the image processor is capable of outputting the second image data for display before outputting the first image data. For example, the selection circuit can be controlled by a timing signal to output the second image data, while the imaging device is being powered up. The output second image data allows the power-up image to be displayed before the captured image is displayed. For example, the timing signal can be generated simultaneously with other initialization functions by the power-up operation of the imaging device. In such a case, the power-up image can be displayed when the imaging device is being powered up. The image processor can switch to output the first image data.

According to a further embodiment, the image processor is capable of automatically outputting the second image data for display when the imaging device is being powered up. For example, the operation of the image processor can be controlled by a timing signal generated in response to the power-up operation of the imaging device. When the image processor is triggered by the timing signal, the image processor can generate and/or output the second image data for display while the imaging device is being powered up. The power-up image can be displayed e.g., during the initialization period of one or more registers in the image processor or a predetermined time period.

According to a still further embodiment, an imaging device can be provided to comprise an image processor, such as that discussed above, and to generate first and second image data representing respectively a captured image and a power-up image. The imaging device is capable of selectively outputting one of such first and second image data for display. For example, the imaging device is capable of outputting the second image data before the first image data and/or automatically outputting the second image data when the imaging device is being powered up. The imaging device can also comprise an image data output circuit for receiving the selected one of the first and second image data from the image processor and outputting the same to a display device for display.

An imaging system can be provided to comprise an imaging device, such as that discussed above, for selectively outputting one of the first and second image data for display. A display device can be provided to receive the selected one of the first and second image data from the imaging device and display a corresponding image represented by the selected image data. The imaging system is capable of displaying the power-up image on the display device before displaying the captured image and/or automatically displaying the power-up image on the display device while the imaging device is being powered up. For example, the imaging system is capable of displaying a power-up image during initialization of the imaging device.

A method is further provided for displaying a power-up image upon startup of an imaging device, which captures one or more images during the normal use of the imaging device. The method can comprise the acts of providing and storing a power-up image in the imaging device. The power-up image can be displayed before a captured image and/or automatically displayed when the imaging device is being powered up. The power-up image can be displayed for a predetermined time period and/or during initialization of the imaging device and then be automatically or manually cut off from display so as to switch to capture images when the imaging device is ready to capture images.

Various embodiments will now be described with reference to the drawings, in which similar components and elements are designated with similar reference numerals having the same last two digits. Redundant description is omitted. Although the embodiments are described in relation to use with a CMOS imaging device, as noted, the invention is not so limited and has applicability to any solid state imaging device.

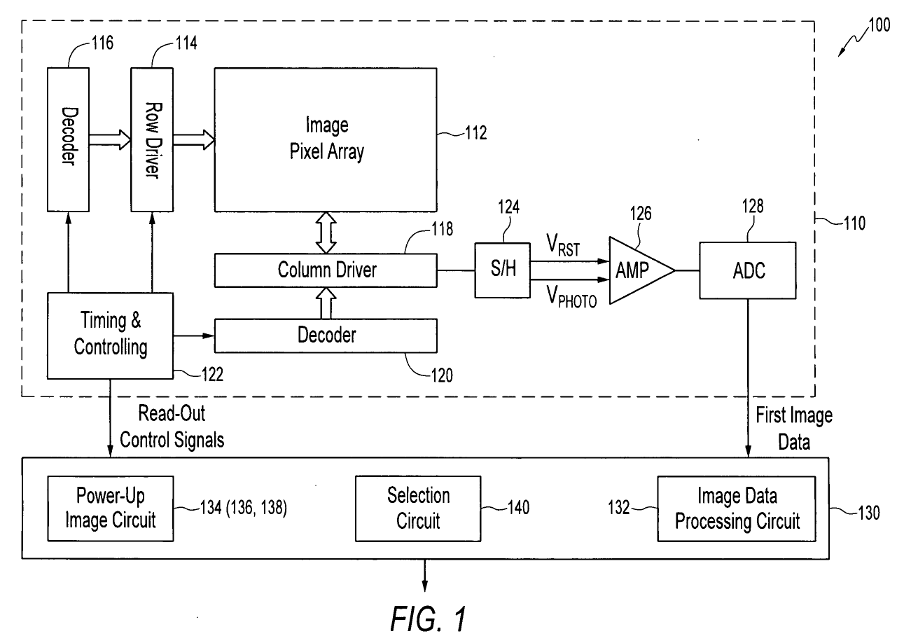

FIG. 1 is a block diagram of an imaging device 100 formed in accordance with various embodiments. The imaging device 100 can comprise an image sensor module 110, such as a single chip CMOS image sensor, for generating first image data representing one or more images captured by the image sensor module 110 during normal use of the imaging device 100. The imaging device 100 can also comprise one or more other components, such as an image processor 130, a power-up circuit 134, or a selection circuit 140, which will be described in great detail below.

The image sensor module 110 can be formed in any of various conventional ways to capture light impinging thereon and generate first image data representing a captured image. For example, the image sensor module 110 can comprise an image pixel array 112 formed with pixel cells arranged in a predetermined number of columns and rows. The incident radiation captured by the image pixel array 112 can be converted to electrical signals, such as analog signals, corresponding to the light captured by the image pixel array 112. In one example, such first image data generated by the image pixel array 112 can represent red, blue, and green light impinged on the image pixel array 112.

The electrical signals obtained and generated by the pixel cells in the image pixel array 112 can be read out row by row to provide the first image data. For example, pixel cells in a row of the image pixel array 112 are all selected for read-out at the same time by a row select line, and each pixel cell in a selected row provides a signal representative of received light to a column output line for its column. In the image pixel array 112, each column also has a select line, and the pixel cells of each column are selectively read out onto output lines in response to the column select lines. The row select lines in the image pixel array 112 are selectively activated by a row driver 114 in response to a row address decoder 116. The column select lines are selectively activated by a column driver 118 in response to a column address decoder 120.

The image sensor module 110 can also comprise a timing and controlling circuit 122, which generates one or more read-out control signals to control the operation of the various components in the image sensor module 110. For example, the timing and controlling circuit 122 can control the address decoders 116, 120 in any of various conventional ways to select the appropriate row and column lines for pixel signal read-out. Additionally or alternatively, the read-out control signals can control the flow of first and second image data within and/or out of the imaging device 100. For example, the read-out control signals can comprise one or more of a pixel clock (Pixclk) signal, a frame valid (FV) signal, and/or a line valid (LV) signal. In one example, the pixel clock signal can be used to synchronize the flow of the first and second image data within and/or output from the imaging device 100. One or more line valid signals can be used to indicate the first image data obtained from those pixel cells representing a valid image.

The electrical signals output from the column output lines typically include a pixel reset signal (Vᵣₛₜ) and a pixel image signal (Vₚₕₒₜₒ) for each pixel cell. Both signals can be read into a sample and hold circuit (S/H) 124. In one example, a differential signal (Vᵣₛₜ−Vₚₕₒₜₒ) can be produced by differential amplifier (AMP) 126 for each pixel cell. Each pixel cell's differential signal can be digitized by an analog-to-digital converter (ADC) 128, which supplies digitized pixel data as the first image data to be output from the image sensor module 110. One skilled in the art would appreciate that the image sensor module 110 and its various components can be in various other forms and/or operate in various other ways. In addition, the imaging device 100 illustrated, is a CMOS imager, but any type of imager core, including a CCD pixel array and associated read-out circuits, and others may be used.

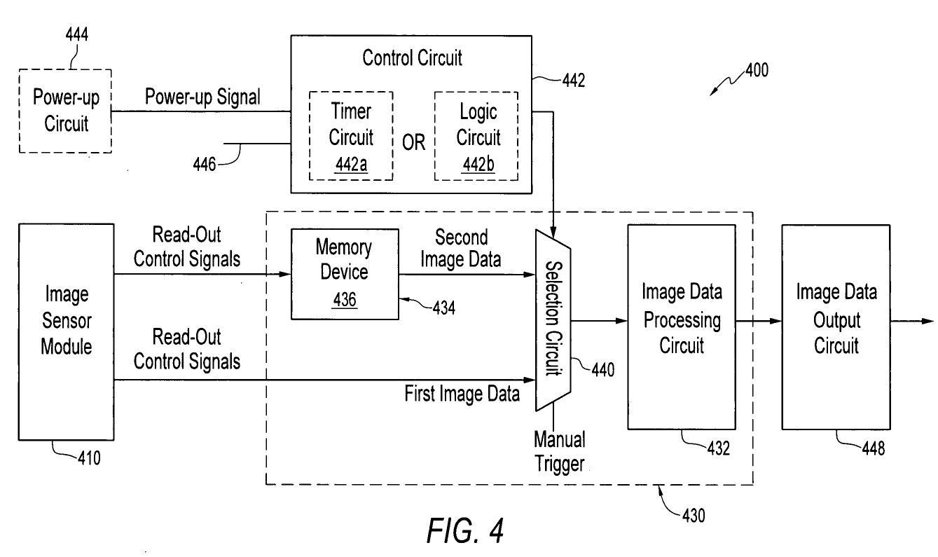

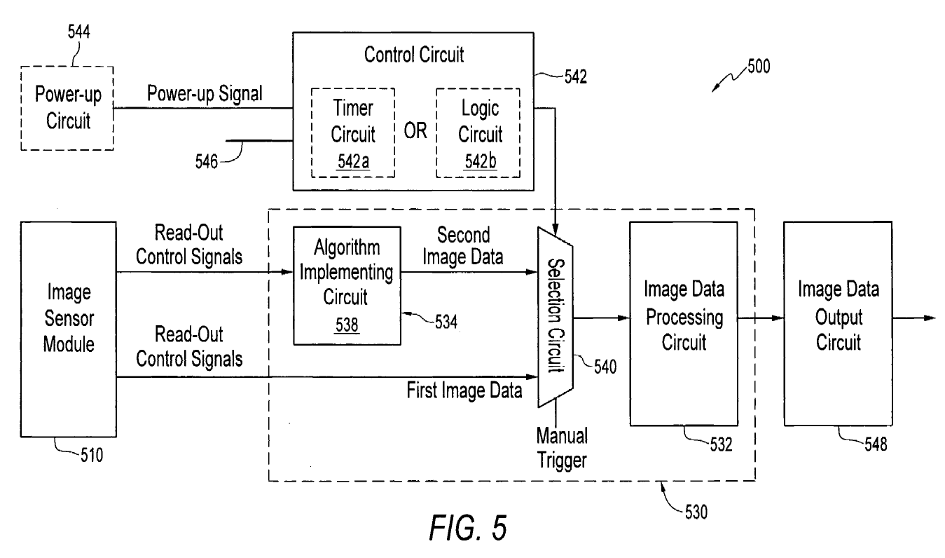

The imaging device 100 can also comprise an image processor 130 formed in any of various ways. In one example, the image processor 130 can comprise an image data processing circuit 132 for receiving and processing first or second image data. For example, the image data can be digitized pixel data, such as pixel data representing red, blue, and green light of one or more captured images, output from the analog-to-digital converter 128. Alternatively, the image data processing circuit 132 can receive and process a selected one of the first and second image data output from a selection circuit 140, as better shown in FIGS. 4 and 5 and will be discussed below.

The image data processing circuit 132 can perform any appropriate data processing, including color recovery, color correction, sharpening, programmable gamma correction, auto black reference clamping, auto exposure, automatic 50 Hz/60 Hz flicker avoidance, lens shading correction, auto white balance, on-the-fly defect identification and correction, day/night mode configurations, special camera effects, such as sepia tone and solarization, and interpolation to an arbitrary image size with continuous filtered zoom and pan. In one example, the image data processing circuit 132 can be formed on the same integrated circuit as the image sensor module 110. One skilled in the art would appreciate that the image data processing circuit 132 can be formed and/or operate in various other ways.

The image processor 130 can be formed in any of various ways to generate and/or output second image data representing a power-up image. For example, the image processor 130 can comprise a power-up image circuit 134 for storing, generating, or otherwise outputting the second image data. In one example, the power-up image circuit 134 can comprise various types of memory device 136, such as a non-volatile memory (e.g., a read only memory (ROM)), in which the second image data can be stored. For example, the power-up image circuit 134 can be an electrically erasable programmable read-only memory (EEPROM), such as flash memory, which allows the user to alter or substitute the power-up image with one of the user's own favorite images during normal use of the imaging device 100.

The memory device 136 of the power-up image circuit 134 can be formed to have various capacities, depending on the format of the power-up image. For example, the power-up image can be one frame of a video graphics array (VGA). When the imaging device 100 is used in a hand-held device, such as a mobile telephone, one frame of a quarter video graphics array (QVGA) can be used. In one example, when the power-up image is one frame of a video graphics array (e.g., with a pixel resolution of 640×480), the memory device 136 can be formed to have a capacity of about 4.8 Mb (e.g., 300K×16). When the power-up image is one frame of a quarter video graphics array (i.e., with a pixel resolution of 320×240), the memory device 136 can have a size of about 1.2 Mb. The capacity of the memory device 136 can also depend on the configuration of the imaging device 100 as will be described below.

Additionally or alternatively, the power-up image circuit 134 can comprise an algorithm implementing circuit 138 formed in any of various conventional ways. In one example, the algorithm implementing circuit 138 can be a programmable logic device programmed with an algorithm for generating a pattern of the power-up image. For example, the programmable logic device programmed with an algorithm 138 can be designed using a register transfer logic (RTL), programmable gate array, application specific integrated circuit (ASIC), using specialized programming languages, such as VHSIC hardware description language (VHDL) or Verilog. The use of the programmable logic device and algorithm 138 can reduce the capacity requirement of the power-up image circuit 134. For example, the size of the power-up image circuit 134 can be less than 4.8 Mb and 1.2 MB respectively for a power-up image of one frame video graphics array and one frame quarter video graphics array.

The programmable logic device and the algorithm 138 can generate the power-up image in any of various ways. In one example, a background and foreground of the power-up image can be separately generated as parts of the power-up image. For example, the background of the power-up image can be generated as a uniform partial image, which is to be combined with a foreground image. The programmable logic device and the algorithm 138 can be configured to identify pixel cells containing a foreground image of the power-up image and maintain address information of such pixel cells so as to generate the foreground image. In another example, the programmable logic device and the algorithm 138 can generate a fraction of the power-up image and repeat the same fraction to create the entire power-up image.

The second image data generated by the power-up image circuit 134 can be in any of various formats. For example, the second image data can have a luminance-chrominance color system, such as in the YUV, YCrCb, or YPbPr color format. In another example, the second image data comprises digitized signals representing red, blue, and green light of the power-up image. If desired, the second image data generated by the power-up image circuit 134 can have the same color format as that of the first image data, either before or after being processed by the image data processing circuit 132.

The power-up image can be provided and stored in the image processor 130 before the imaging device 100 is being powered up to capture an image or during normal use of the imaging device 100 or other image processor 130. For example, the power-up image can be any information relating to the imaging device 100 or a company logo that the manufacturer created when making the imaging device 100 or the image processor 130. Additionally or alternatively, the power-up image can be altered and/or created by the user. For example, during normal use of the imaging device 100, the user can select any desired image and store such desired image in the power-up image circuit 134, to substitute the manufacturer created power-up image (e.g., product information of the imaging device 100). One skilled in the art would appreciate that second image data and the power-up image can be generated in various other ways and/or forms.

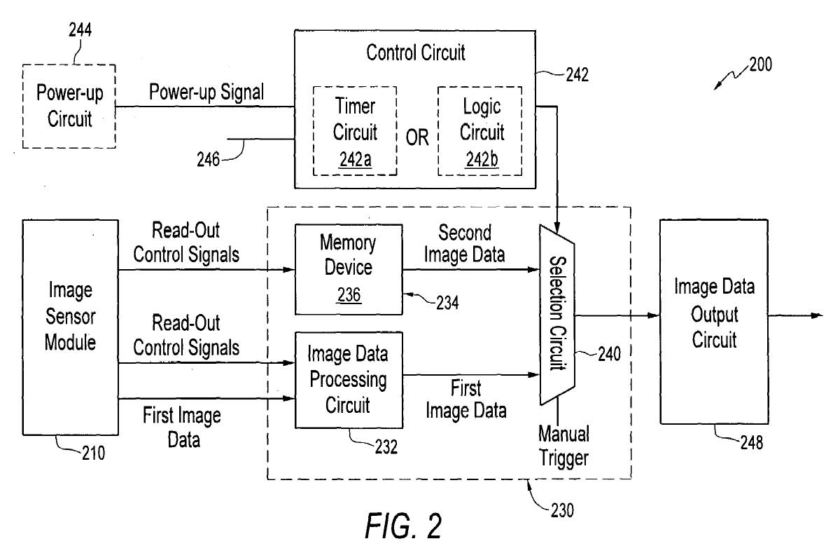

The image processor 130 can be formed in any of various ways to selectively output one of the first and second image data. For example, the image processor 130 can comprise a selection circuit 140, which can receive both first and second image data and output one of such first and second image data. In one example, the second image data can be output to display the power-up image when the image processor 130 is being initialized. The power-up image can be displayed for a predetermined time period or until the completion of initialization, after which the first image data can be output so that the captured image can be displayed. For example, the image processor 130 can output the second image data before outputting the first image data, when the imaging device is being powered up. Additionally or alternatively, the image processor 130 can automatically output the second image data, when the imaging device is being powered up. The detailed description of selectively outputting the first and second image data is now provided in conjunction with FIGS. 2 to 5.

FIG. 2 shows a second imaging device 200 formed to comprise an image sensor module 210 and an image processor 230 including an image data processing circuit 232 and a power-up image circuit 234, which can be formed similarly to their counterparts in the imaging device 100 discussed above. For example, the image sensor module 210 can generate and output the first image data of one or more captured images. The image data processing circuit 232 is coupled to the image sensor module 210 for receiving pixel data from the image sensor module 210 and outputting digitized pixel data as the first image data. The power-up image circuit 234 is in the form of a memory device 236, such as a non-volatile memory, which stores and outputs the second image data representing the power-up image. The output first and second image data can be in the same format, such as e.g., the RGB or YUV or other color space. In the example shown in FIG. 2, the image sensor module 210 generates and outputs one or more read-out control signals to the image data processing circuit 232 and the power-up image circuit 234.

The imaging device 200 can be formed in any of various ways to selectively output one of the first and second image data for display. For example, the imaging device 200 can comprise a selection circuit 240, which is capable of receiving signals from multiple sources and selectively outputting one of such signals. In one example, a multiplexer 240 can be employed to receive both first and second image data and selectively output one of such first and second image data. In the example shown in FIG. 2, the selection circuit 240 can be coupled respectively to the image data processing circuit 232 and the power-up image circuit 234 for receiving the first and second image data therefrom.

The operation of the selection circuit 240 can be controlled by a control circuit 242 formed in any of various ways. The control circuit 242 can provide a timing signal in any of various ways and supply such timing signal to the selection circuit 240 to selectively output one of the first and second image data. For example, the timing signal can be generated in response to the power-up operation of the imaging device 200 to operate the selection circuit 242 to output the second image data. In one example, when the imaging device 200 is being powered up, the control circuit 242 can create one or more rising edges of the timing signal. When such timing signal is in turn supplied to the selection circuit 240, each rising edge operates the selection circuit 240 to output the second image data.

Optionally, a power-up circuit 244 can be provided for generating a power-up signal in response to a power-up operation of the imaging device 200. For example, the power-up signal can be sent to the control circuit 242 to generate the timing signal.

The control circuit 242 can be formed in any of various ways and operate the selection circuit 242 to output the first image data. In one example, the control circuit 242 can comprise a timer circuit 242a. The timer circuit 242a can generate a timing signal having a rising edge, such as discussed above, and a falling edge. The selection circuit 240 can be configured to begin outputting the second image data on the rising edge of the timing signal, as discussed above and continue outputting the second image data for a predetermined time period until the falling edge is reached. For example, the predetermined time period can be that required to initiate one or more registers in the imaging device 200. In an example, the predetermined time period can be about one second. The selection circuit 240 can switch to output the first image data on the falling edge of the timing signal. For example, the first image data can be output after the predetermined time period expires. In one example, the first image data is output when initialization is completed.

In an alternative example, the control circuit 242 can comprise a logic circuit 242b. The logic circuit 242b can generate a first timing signal in response to the power-up operation of the imaging device 200, similarly to the above discussed timing signal, and supply such first timing signal to the selection circuit 240. The first timing signal can operate the selection circuit 240 to output the second image data. For example, the first timing signal can have a rising edge, similar to that in the timing signal discussed above.

Additionally or alternatively, the logic circuit 242b can provide a second timing signal to the selection circuit 240 and switch the selection circuit 240 from outputting the second image data to outputting the first image data. The second timing signal can be generated in response to an output from the image sensor module 210 or the image data processing circuit 232, and/or the resultant input to the selection circuit 242, after power-up initialization is completed. For example, the input to the selection circuit 242 from the image data processing circuit 232 can be used as the second timing signal. In one example, when a captured image is sent as first image data to the selection circuit 240, the logic circuit 242b is triggered to generate a second timing signal. In another example, one of the control signals (e.g., pixel clock, frame valid, and line valid signals) generated by the image sensor module 210 can trigger the second timing signal to switch the selection circuit 242 to output the first image data. For example, the first frame valid signal output from the image sensor module 210 can be used as the second timing signal.

In the example shown in FIG. 2, the input to the selection circuit 240 can pass through the image data processing circuit 232 after being generated by the image sensor module 210. Alternatively, the input to the selection circuit 240 can be received from the image sensor module 410, 510 (see FIGS. 4 and 5, respectively). Accordingly, the image sensor module 410, 510 as shown in FIG. 4 or 5 and/or the image data processing circuit 232 can be used to control the output of the first image data from the selection circuit 240.

The timer circuit 242a can comprise a timer adjustment terminal 246, so that the user can adjust the duration of the timing signal, during which the second image data is output from the selection circuit 240. The duration of the timing signal can be the time period required for system initialization of the imaging device 200 or can otherwise be determined by the user. For example, the timing signal can last for a predetermined time period, such as from zero seconds up to the time period required for system initialization. When the duration of the timing signal is set to zero seconds, the operation of outputting a power-up image is discontinued. In one example, the timing signal can last for at least one second. In another example, the timing signal can be maintained at the higher level to allow outputting of the second image data until the timing signal is manually discontinued. The selection circuit 240 can then output the first image data representing a captured image. One skilled in the art would appreciate that control circuit 242, the timer circuit 242a, and/or the logic circuit 242b can be formed in various other ways.

Additionally or alternatively, the imaging device 200 can be formed in any of various ways to output the second image data before outputting the first image data and/or automatically output the second image data to display the power-up image when the imaging device 200 is being powered up. For example, in response to the power-up operation of the imaging device 200, a timing signal can be generated which enables the selection circuit 240 to output the second image data as soon as the power-up operation is initiated. The power-up image can be displayed while the imaging device 200 is being powered up and/or during initialization of the imaging device 200. When one or more registers in the imaging device 200 are undergoing initialization, the first image data cannot reach the selection circuit 240. Accordingly, the automatically displayed power-up image can be shown before any captured image is displayed during initialization of the imaging device 200.

In another example, the imaging device 200 can automatically output the second image data regardless of whether the first image data is being output. For example, the timing signal generated can have a delayed rising edge. For example, the delayed time period can be set to be longer than the time period needed for initialization. In such a case, the selection circuit 240 can output the first image data after system initialization is completed, as is discussed above. When the delayed time period expires, the delayed rising edge of the timing signal triggers the selection circuit 240 to automatically output the second image data. The display can thus be switched from captured images to the power-up image, such as one of the user's favorite images previously stored in the power-up image circuit 234.

The second image data can be output for a time period, which can be determined according to various factors, such as the configuration of the imaging device 200, or by the user's preference. For example, a predetermined time period can be set from zero to several seconds, or to a time period set by the user to output the second image data. In one example, the time period is set to enable the selection circuit 240 to continuously output the second image data until initialization of the imaging device 200 is completed. In such a case, the power-up image can be displayed during the initialization of the imaging device 200. In another example, the user can set the time period as desired, such as by using the timer adjustment terminal 246 during normal use of the imaging device 200. When the imaging device 200 is being powered up the next time, the user can view the power-up image (e.g., one of the user's favorite images stored in the power-up image circuit 234) for an extended time period, even after the completion of system initialization. In a further example, the second image data can be continuously output until a manual trigger is activated by the user to output the first image data.

The first image data of a captured image can be output from the selection circuit 240 when the time period for outputting the second image data expires. In one example where the time period is set to be the same as the time period required to initialize the imaging device 200, the first image data can be output from the selection circuit 240 as soon as system initialization is completed. In such a case, the power-up image will not interfere with the display of captured images. In another example, the outputting of the second image data can continue until a manual intervention is input. For example, the imaging system 200 can be formed to allow the user to manually trigger and enable the selection circuit 240 to output the first image data when desired. Such manual trigger operation can effect the output of the first image data after the completion of system initialization. One skilled in the art would appreciate that the selection circuit 240 and the timing signal can be configured and formed in various other ways.

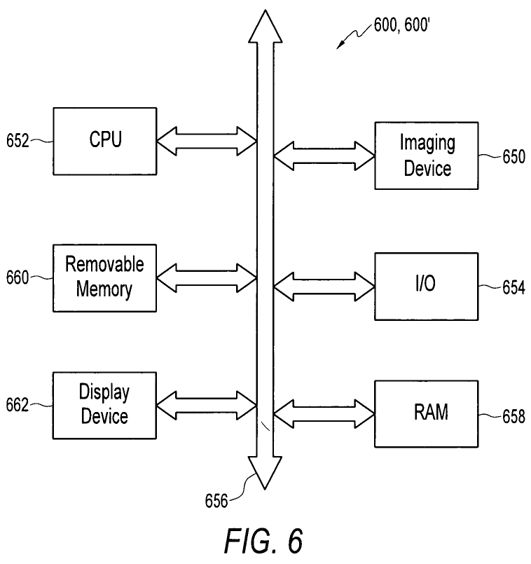

The imaging device 200 can also be formed to comprise an image data output circuit 248 for receiving the image data output by the selection circuit 240. The output of the image data output circuit 248 can be an image output for display purposes. For example, any of various conventional output drivers can be used to supply the image output to a display device 662 (FIG. 6). In one example, the image data output circuit 248 can comprise one or more output terminals (not shown) to be coupled to a display device. One skilled in the art would appreciate that the image data output circuit 248 can be configured and formed in various other ways.

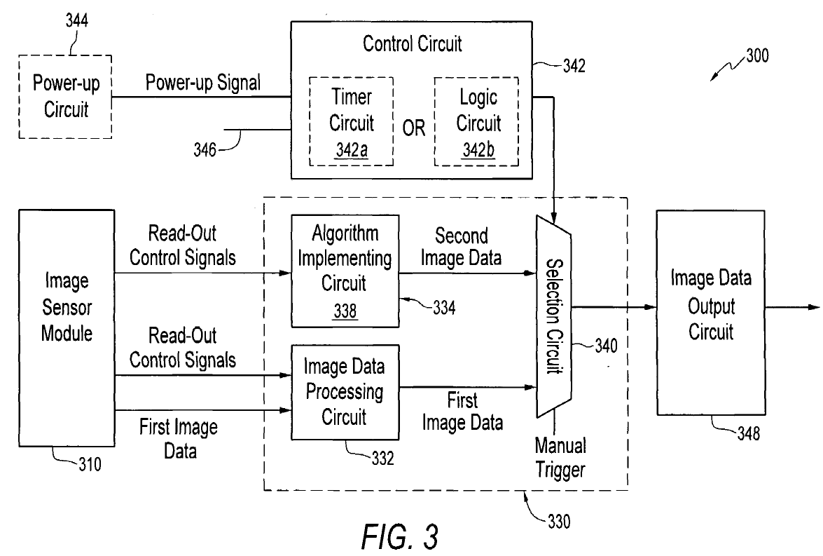

FIG. 3 shows a third imaging device 300, which is formed similarly to imaging device 200 shown in FIG. 2. In the illustrated example, the imaging device 300 has a different type of power-up image circuit 334, which can be formed to comprise an algorithm implementing circuit 138. For example, the algorithm implementing circuit 338 can be in the form of a programmable logic device programmed with an algorithm, similar to the programmable logic device and algorithm 138 discussed above. The second image data generated by and output from the power-power-up image circuit 334 can have e.g., RGB, YCrCb, or other color space. The power-up image circuit 334 so formed can have a reduced storage capacity than that of the power-up image circuit 234.

FIG. 4 shows a fourth imaging device 400 constructed in accordance with another embodiment. In this example, an image data processing circuit 432 is provided and coupled between a selection circuit 440 and an image data output circuit 448 and processes one of the first and second image data output from the selection circuit 440. The selection circuit 440 can receive first image data, which is in the form of pixel data, directly from the image sensor module 410. The second image data output from the power-up image circuit 434, such as a memory device 436, can also be in pixel data form.

FIG. 5 shows a fifth imaging device 500, which is formed similarly to imaging device 400 shown in FIG. 4. In this example, the imaging device 500 has a different type of power-up image circuit 534, which can be formed to comprise an algorithm implementing circuit 538. For example, the algorithm implementing circuit 538 can be in the form of a programmable logic device programmed with an algorithm, similar to the programmable logic device and algorithm 138 discussed above. The power-up image circuit 534 so formed can have a reduced capacity than that of the power-up image circuit 434.

FIG. 6 illustrates an imaging system 600 including an imaging device 650, such as one of the imaging devices 100, 200, 300, 400, 500 discussed above. The imaging system 600 can be any of various systems having digital circuits that could include the imaging device 650. Without being limiting, such a system could include a computer system, a camera system (such as digital cameras including digital still cameras, digital movie cameras, and digital cameras performing both operations), a scanner, a machine vision, a vehicle navigation, a video phone system (e.g., a camera mobile phone), a surveillance system, an auto focus system, a star tracker system, a motion detection system, and other systems supporting image acquisition.

The imaging system 600 can generally comprise a central processing unit (CPU) 652, such as a microprocessor, that communicates with an input/output (I/O) device 654 over a bus 656. The imaging system 600 can also comprise random access memory (RAM) 658, and can include removable memory 660, such as flash memory, which can communicate with CPU 652 over the bus 656. In one example, the input/output (I/O) device 654 can comprise a display device 662 on which the power-up image and the captured image(s) are selectively displayed. The display device 662 can also communicate with CPU 652 over the bus 656.

In one example, the display device 662 can be formed to receive a selected one of the first and second image data output from the imaging device 650 and display a corresponding image. As is discussed in various embodiments and examples above, the imaging device 650 can output the second image data representing a power-up image stored in the image device 650 prior to outputting any captured image and/or automatically output the second image data when the imaging device 650 is being powered up. The display device 662 can thus display the power-up image before displaying any captured image and/or automatically display the power-up image when the imaging device 650 is being powered up. For example, the display device 662 can display the power-up image when one or more registers in the imaging device 650 are being initialized. In one example, the power-up image can be displayed for at least a predetermined time period, such as during the initialization period of the imaging device 650. The captured image can be displayed after the predetermined time period expires.

The imaging system 600 can be in various forms, such as a video telephone camera system (e.g., a mobile telephone equipped with a camera 600′). The imaging device 650 contained in the camera mobile phone 600′ can communicate with the CPU 652 and selectively output one of the first and second image data to the CPU 652 over the bus 656. The imaging device 650 may be combined with a processor, such as a CPU, digital signal processor, or microprocessor, with or without memory storage on a single integrated circuit or on a different chip than the processor. The CPU 652 is configured to be capable of processing the selected one of the first and second image data received from the imaging device 650 and/or outputting the selected image data to the display device 662 for display.

The camera mobile phone 600′ can be used as a telephone unit, without activating the video or camera function. In such a case, the imaging device 650 in the camera mobile phone 600′ is not in use and the display device 662 of the camera mobile phone 600′ can display various manus used with a typical mobile telephone unit or otherwise display incoming and outgoing telephone numbers. When the user wishes to use the camera mobile phone 600′ to take a picture, the user can activate the camera function on camera mobile phone 600′, such as be pressing a camera button.

Upon such activation, the camera mobile phone 600′ is switched from a telephone mode to a camera mode to capture images; the various displays in connection with the telephone mode are cut off. At the same time, the imaging device 650 in the camera mobile phone 600′ will undergo system initialization so that one or more registers of the imaging device 650 can be initialized. As is discussed above, the imaging device 650 is capable of outputting the second image data during the initialization time period to display the power-up image on the display device 662. One skilled in the art will appreciate that the imaging device 650, the imaging system 600, and other various components contained therein can be formed and/or operate in various other ways.

It is again noted that although the above embodiments are described with reference to a CMOS imaging device, the invention is not limited to CMOS imaging devices and can be used with other imaging device technology (e.g., CCD technology) as well.

It will be appreciated that the various features described herein may be used singly or in any combination thereof. Therefore, the invention is not limited to only the embodiments specifically described herein. While the foregoing description and drawings represent examples of the invention, it will be understood that various additions, modifications, and substitutions may be made therein as defined in the accompanying claims. In particular, it will be clear to those skilled in the art that the invention may be embodied in other specific forms, structures, arrangements, proportions, and with other elements, materials, and components, without departing from the essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the invention. The presently disclosed embodiments are therefore to be considered in all respects as illustrative and not restrictive.

What is claimed as new and desired to be protected by Letters Patent of the United States is:

1. An imaging device comprising:
an image sensor module for generating first image data representing an image captured by the image sensor module;
a power-up image circuit for providing second image data representing a power-up image; and
a selection circuit for selectively providing one of the first and second image data as output image data.

2. The imaging device of claim 1, wherein the power-up image circuit comprises a memory device storing the second image data.

3. The imaging device of claim 2, wherein the memory device comprises a non-volatile memory.

4. The imaging device of claim 2, wherein the memory device comprises an EEPROM so that the power-up image can be altered.

5. The imaging device of claim 1, wherein said power-up image circuit comprises a circuit for implementing an algorithm for generating the second image data.

6. The imaging device of claim 5, wherein the algorithm implementing circuit generates image data forming a background image and a foreground image as parts of the power-up image.

7. The imaging device of claim 5, wherein the algorithm implementing circuit comprises a programmable logic device.

8. The imaging device of claim 1, wherein the power-up image circuit further comprises a memory device having a capacity of less than 4.8 Mb when the power-up image is one frame of a video graphics array.

9. The imaging device of claim 1, wherein the power-up image circuit further comprises a memory device having a capacity of less than 1.2 Mb when the power-up image is one frame of a quarter video graphics array.

10. The imaging device of claim 1, wherein the second image data represents one frame of a video graphics array display.

11. The imaging device of claim 1, wherein the second image data represents one frame of a quarter video graphics array display.

12. The imaging device of claim 1, wherein the second image data has the same color format as that of the first image data.

13. The imaging device of claim 1, wherein the power-up image is stored in the power-up image circuit when the imaging device is in use.

14. The imaging device of claim 1, wherein the selection circuit is capable of outputting the second image data before outputting the first image data while the imaging device is being powered up.

15. The imaging device of claim 1, wherein the selection circuit is capable of automatically outputting the second image data before outputting the first image data while the imaging device is being powered up.

16. The imaging device of claim 1, wherein the selection circuit provides the first image data as output image data a predetermined time period after it begins to provide the second image data as output image data.

17. The imaging device of claim 1 further comprising a control circuit for generating a timing signal when the imaging device is being powered up,
wherein the timing signal is input into the selection circuit to select the output of one of the first and second image data.

18. The imaging device of claim 17, wherein the control circuit is responsive to the presence of a power-up signal to generate the timing signal.

19. The imaging device of claim 17, wherein the timing signal operates the selection circuit to output the second image data for a predetermined time period.

20. The imaging device of claim 19, wherein the control circuit is operable to adjust the length of time the second image data is output from the selection circuit.

21. The imaging device of claim 17, wherein the control circuit is operable to enable the selection circuit to output the first image data when such first image data is received by the selection circuit.

22. The imaging device of claim 17, wherein the control circuit is operable to enable the selection circuit to output the first image data when the image sensor module outputs a read-out control signal.

23. The imaging device of claim 1 further comprising an image data output circuit for receiving a selected one of the first and second image data output by the selection circuit and generating an image output for display.

24. The imaging device of claim 1 further comprising an image data processing circuit for processing the first image data before outputting the same to the selection circuit.

25. The imaging device of claim 1 further comprising an image data processing circuit for processing a selected one of the first and second image data output by the selection circuit.

26. The imaging device of claim 1, wherein the image sensor module comprises:
a pixel array for receiving light impinging on the pixel array; and
a read-out circuit for generating and outputting the first image data based on the light captured by the pixel array.

27. The imaging device of claim 26, wherein the first image data comprises color components of light impinging on the pixel array.

28. The imaging device of claim 1, wherein the image sensor module outputs a read-out control signal for controlling the flow of first and second image data within and/or out of the imaging device.

29. An imaging device comprising:
an image sensor module for generating first image data representing an image captured by the image sensor module; and
an image processor for receiving and processing the first image data, the image processor comprising a power-up image circuit for providing second image data representing a power-up image;
wherein the image processor outputs the second image data before outputting the first image data.

30. The imaging device of claim 29, wherein the image processor automatically outputs the second image data while the imaging device is being powered up.

31. The imaging device of claim 29, wherein the image processor outputs the first image data after a predetermined period of time.

32. The imaging device of claim 29, wherein the image processor outputs the first image data after the imaging device is powered up.

33. The imaging device of claim 29, wherein the image processor further comprises a selection circuit for receiving both first and second image data and for outputting one of the first and second image data.

34. An imaging device comprising:
an image sensor module for generating first image data representing an image captured by the image sensor module; and
an image processor for receiving and processing the first image data, the image processor comprising a power-up image circuit for providing second image data representing a power-up image;
wherein the image processor automatically outputs the second image data while the imaging device is being powered up.

35. The imaging device of claim 34, wherein the image processor outputs the first image data after a predetermined period of time.

36. The imaging device of claim 34, wherein the image processor outputs the first image data after the imaging device is powered up.

37. The imaging device of claim 34, wherein the image processor further comprises a selection circuit for receiving both first and second image data and for outputting one of the first and second image data.

38. An imaging system comprising:
an imaging device for generating first image data representing a captured image and second image data representing a power-up image, the imaging device selectively outputting one of the first and second image data; and
a display device receiving a selected one of the first and second image data from the imaging device and displaying an image represented by the selected image data.

39. The imaging system of claim 38, wherein the imaging device comprises an image sensor module generating and outputting a read-out control signal controlling the flow of first and second image data within and/or out of the imaging device.

40. The imaging system of claim 38, wherein the imaging device comprises a memory device storing the second image data.

41. The imaging system of claim 38, wherein the imaging device comprises a circuit for implementing an algorithm for generating the second image data.

42. The imaging system of claim 38, wherein the display device displays the power-up image before displaying a captured image.

43. The imaging system of claim 38, wherein the display device displays the power-up image while the imaging device is being powered up.

44. The imaging system of claim 38, wherein the display device automatically displays the power-up image.

45. The imaging system of claim 38, wherein the display device displays a captured image after the predetermined time period expires.

46. The imaging system of claim 38 further comprising a manual trigger enabling the imaging device to output the first image data for display.

47. The imaging system of claim 38 being a camera mobile phone.

48. An image processor for use in an imaging device, the image processor comprising:
an image data processing circuit for receiving and processing first image data representing a captured image; and
a power-up image circuit for generating second image data representing a power-up image;
wherein one of the first and second image data is selectively output from the image processor as output image data.

49. The image processor of claim 48, wherein the second image data is output before the first image data.

50. The image processor of claim 48, wherein the second image data is output when the image data processing circuit is undergoing initialization.

51. The image processor of claim 48 further comprising a selection circuit receiving both first and second image data and selectively outputting one of the first and second image data.

52. The image processor of claim 51 further comprising a control circuit for generating a timing signal while the image processor is being powered up, wherein the timing signal is input into the selection circuit to select the output of one of the first and second image data.

53. A method of displaying a power-up image on an imaging system, the method comprising the acts of:
providing an imaging device for capturing a first image; and
storing a power-up image in the imaging device for display before displaying a captured first image while the imaging device is being powered up.

54. The method of claim 53 further comprising the act of providing a timing signal controlling output of the power-up image.

55. The method of claim 54, wherein the timing signal controls a display time period for the power-up image.

56. The method of claim 53 further comprising the act of displaying the power-up image before displaying a captured first image.

57. The method of claim 53, wherein the power-up image is displayed for a predetermined time period, which is adjustable.

58. The method of claim 53 further comprising the act of displaying the captured image after a predetermined time period.

59. The method of claim 53 further comprising the act of displaying the captured image after the imaging device is powered up.

60. A method of displaying a power-up image on an imaging system, the method comprising the acts of:
providing an imaging device for capturing a first image; and
storing a power-up image in the imaging device to be displayed automatically when the imaging device is being powered up.

61. The method of claim 60 further comprising the act of displaying the power-up image before displaying a captured first image.

62. The method of claim 60 further comprising the act of displaying a captured image after the imaging device is being powered up.

63. The method of claim 60 further comprising the act of displaying a captured image after a predetermined time period.
